(19) United States
(12) Patent Application Publication
(10) Pub. No.: US 2023/0249925 A1
(43) Pub. Date: Aug. 10, 2023

(54) AUGER ASSEMBLY

(71) Applicant: Jason Theodore Freadrich, Killam (CA)

(72) Inventor: Jason Theodore Freadrich, Killam (CA)

(21) Appl. No.: 17/668,596

(22) Filed: Feb. 10, 2022

(51) Int. Cl. B65G 65/00; B65G 33/14; B65G 67/04

(52) U.S. Cl. CPC B65G 65/005; B65G 33/14; B65G 67/04; B65G 2201/042

(57) ABSTRACT

An auger assembly for conveying a material includes an auger including a conveyor for transporting the material from a storage bin to a transport vehicle. The auger assembly also includes a power source operatively coupled to the conveyor to operate the conveyor. The auger assembly includes a first sensor, a second sensor, and a controller. The first sensor is engaged to the auger and configured to detect a flow of the material from an outlet of the auger. The second sensor is configured to detect a filling of the material inside the transport vehicle to a desired level. The controller is in communication with the first sensor, the second sensor, the power source and the auger, and is configured to control the power source based on inputs from at least one of the first sensor or the second sensor.

### TECHNICAL FIELD

The present disclosure relates to an auger assembly for transferring a material. More particularly, the present disclosure pertains to an auger assembly having sensors for controlling an operation of the auger assembly.

### BACKGROUND

Auger powered by a power source, for example, an internal combustion engine, for transferring materials, such as, grains, from a storage bin to a transport vehicle is well known in the art. During transfer of the material, an operator needs to monitor the filling of the material in the transport vehicle so that the auger can be stopped after the transport vehicle is filled to the desire level. Often, the operator may not stop the auger at the appropriate time, resulting into the spillage of the material, which is undesirable. Further, the storage bin may run out of the material during filling of the transport vehicle, and the operator may not be aware of the fact the storage bin has become empty. Accordingly, the power source is kept running, leading to a loss in efficiency, which is undesirable.

### SUMMARY

According to an aspect of the disclosure an auger assembly for conveying a material is disclosed. The auger assembly includes an auger including a conveyor for transporting the material from a storage bin to a transport vehicle. The auger assembly also includes a power source operatively coupled to the conveyor to operate the conveyor. The auger assembly includes a first sensor, a second sensor, and a controller. The first sensor is engaged to the auger and configured to detect a flow of the material from an outlet of the auger. The second sensor is configured to detect a filling of the material inside the transport vehicle to a desired level. The controller is in communication with the first sensor, the second sensor, the power source and the auger, and is configured to control the power source based on inputs from at least one of the first sensor or the second sensor.

In some embodiments, the controller is configured to determine a stoppage of the flow of the material from the outlet of the auger based on the inputs from the first sensor, and shut-down the power source in response to the determination of the stoppage of the flow of the material from the outlet of the auger.

In some embodiments, the controller is configured to determine the stoppage of the flow of the material from the outlet of the auger when the material ceases to exit from the outlet of the auger for a predetermined duration.

In some embodiments, the first sensor is a limit switch and is positioned at the outlet of the auger to contact the material exiting the auger.

In some embodiments, the controller is configured to shut-down the power source in response to the determination of the filling of the transport vehicle to the desired level based on the inputs from the second sensor.

In some embodiments, the auger assembly further includes a light source. The controller is configured to actuate the light source in response to the determination of the filling of the transport vehicle to the desired level based on the inputs from the second sensor.

In some embodiments, the second sensor is a limit switch and the controller shut down the power source in response to a contact of the limit switch with an agglomerate of material arranged inside the transport vehicle.

In some embodiments, the auger assembly further includes a first switch adapted to activate an auto mode. The controller is in communication with the first switch and is configured to control the power source based on the inputs from the at least one of the first sensor or the second sensor in response to the activation of the auto mode.

In some embodiments, the auger assembly further includes a second switch adapted to move between a first position to activate the auto mode as a first auto mode and a second position to activate the auto mode as a second auto mode.

In some embodiments, in the first auto mode, the controller is configured to shut down the power source in response to one of the determination of a stoppage of the flow of the material from the outlet of the auger based on the inputs from the first sensor, or the determination of the filing of the material inside the transport vehicle to the desired level based on the inputs from the second sensor.

In some embodiments, in the second auto mode, the controller is configured to shut down the power source in response to the determination of the filing of the material inside the transport vehicle to the desired level based on the inputs from the second sensor.

In some embodiments, in the second auto mode, the controller is configured to keep the power source running in response the determination of a stoppage of the flow of the material from the outlet of the auger based on the inputs from the first sensor.

In some embodiments, the power source is an engine.

In some embodiments, the conveyor is a screw conveyor.

According to another aspect of the disclosure, a method for operating an auger assembly is disclosed. The method includes detecting, by a first sensor, a flow of a material from an outlet of an auger, and detecting, by a second sensor, a filing of the material inside the transport vehicle to a desire level. The method further includes controlling, by a controller, a power source operating a conveyor of the auger based on inputs from the first sensor and the second sensor.

In some embodiments, the method further includes activating an auto mode by actuating a first switch. The controller controls the power source based on inputs from at least one of the first sensor or the second sensor in response to the activation of the auto mode.

In some embodiments, the method also includes activating the auto mode as a first auto mode when a second switch is arranged at a first position. In the first auto mode, the controller shutdown the power source in response to the determination of the filling of the transport vehicle to the desired level based on the inputs from the second sensor, or the determination of the stoppage of the flow from the outlet of the auger based on the inputs from the first sensor.

In some embodiments, the method further includes activating the auto mode as a second auto mode when a second switch is arranged at a second position. In the second auto mode, the controller shutdown the power source in response to the determination of the filling of the transport vehicle to the desired level based on the inputs from the second sensor.

In some embodiments, the method further includes activating a light source in response to the determination of the filling of the transport vehicle to the desired level based on the inputs from the second sensor.

In some embodiments, each of the first sensor and the second sensor is a limit switch.

For a more complete understanding of the present invention, reference is made to the following detailed description and accompanying drawings. In the drawing, like reference characters refer to like parts throughout the views.

### BRIEF DESCRIPTION OF THE DRAWINGS

FIG. 1 illustrates a front schematic view of an auger assembly positioned to deliver a material from storage bin to a transport vehicle, in accordance with an embodiment of the disclosure; and

FIG. 2 illustrates an enlarged portion of the auger assembly depicting a first sensor and a second sensor, in accordance with an embodiment of the disclosure.

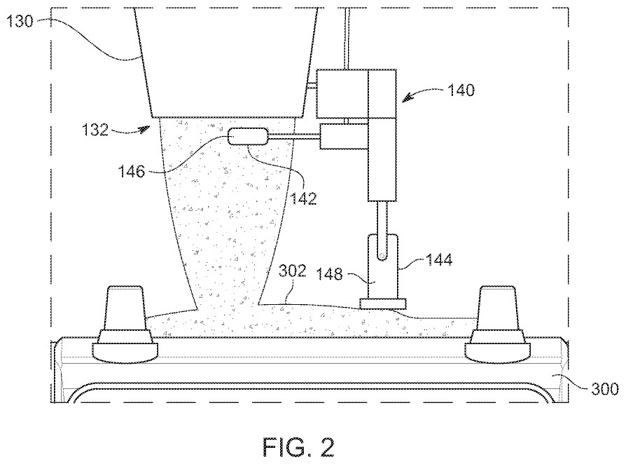

### DETAILED DESCRIPTION

Example embodiments are described below with reference to the accompanying drawings. Unless otherwise expressly stated in the drawings, the sizes, positions, etc., of components, features, elements, etc., as well as any distances therebetween, are not necessarily to scale, and may be disproportionate and/or exaggerated for clarity.

The terminology used herein is for the purpose of describing particular example embodiments only and is not intended to be limiting. As used herein, the singular forms “a,” “an” and “the” are intended to include the plural forms as well, unless the context clearly indicates otherwise. It should be recognized that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another. For example, one element could be termed a “first element” and similarly, another element could be termed a “second element,” or vice versa. The section headings used herein are for organizational purposes only and are not to be construed as limiting the subject matter described.

Unless indicated otherwise, the terms “about,” “thereabout,” “substantially,” etc. mean that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Spatially relative terms, such as “right,” left,” “below,” “beneath,” “lower,” “above,” and “upper,” and the like, may be used herein for ease of description to describe one element's or feature's relationship to another element or feature, as illustrated in the drawings. It should be recognized that the spatially relative terms are intended to encompass different orientations in addition to the orientation depicted in the figures. For example, if an object in the figures is turned over, elements described as “below” or “beneath” other elements or features would then be oriented “above” the other elements or features. Thus, the term “below” can, for example, encompass both an orientation of above and below. An object may be otherwise oriented (e.g., rotated 90 degrees or at other orientations) and the spatially relative descriptors used herein may be interpreted accordingly.

Unless clearly indicated otherwise, all connections and all operative connections may be direct or indirect. Similarly, unless clearly indicated otherwise, all connections and all operative connections may be rigid or non-rigid.

Like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

Many different forms and embodiments are possible without deviating from the spirit and teachings of this disclosure and so this disclosure should not be construed as limited to the example embodiments set forth herein. Rather, these example embodiments are provided so that this disclosure will be thorough and complete, and will convey the scope of the disclosure to those skilled in the art.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments.

For the purposes of the present disclosure, at least one of A, B, or C includes, for example, A only, B only, or C only, as well as A and B, A and C, B and C; or A, B, and C, or any other all combinations of A, B, and C.

For the purposes of the present disclosure, one of A or B includes, for example, A only, B only.

For the purposes of the present disclosure, one of A and B includes, for example, A only, B only.

As used herein, the term “controller” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

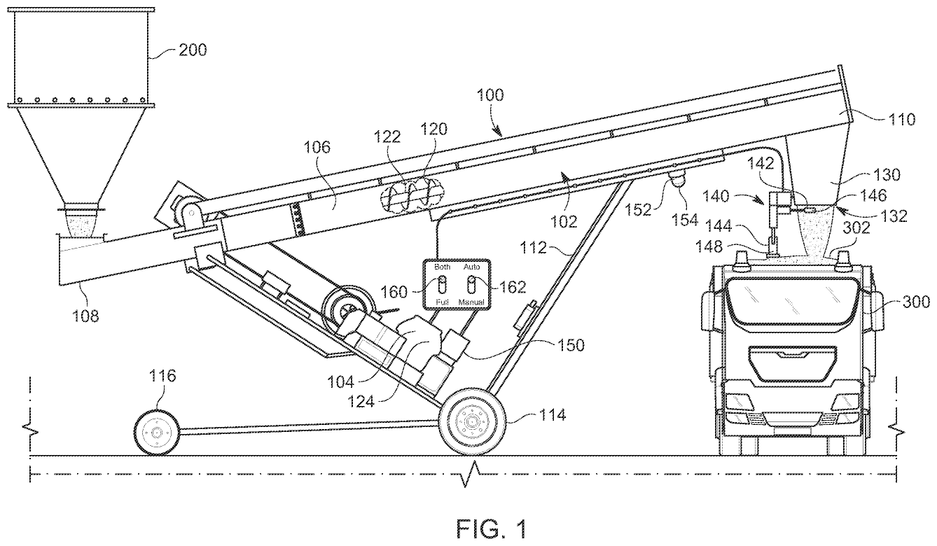

Referring to FIG. 1, an auger assembly 100 arranged to transfer a material, for example, grains, from a hopper or a storage bin 200 to a transport vehicle 300, for example, a truck 300 is shown. The storage bin 200 acts as a storage for the material, and the material flow from the storage bin 200 to an auger 102 of the auger assembly 100. As shown, the auger assembly 100 includes the auger 102 and a power source 104 for powering the auger 102 and various other components of the auger assembly 100. As shown, the auger 102 includes a tube 106 having a lower end 108 adapted to be arranged underneath an outlet of the hooper 200 to receive the material, and an upper end 110 adapted to arranged above the transport vehicle 300 to enable a pouring/transferring of the material to a bed of the transport vehicle 300. As shown, the tube 106 extends at an inclination relative to a horizontal surface, and is supported by a frame 112 which in turn may be supported on a surface, for example, ground, via a plurality of wheels 114. Similarly, the power source 104 may be supported in a plurality of wheels 116. The wheels 114, 116 enable a movement of the auger assembly 100 from one location to another location and helps in a correct/desired positioning of the auger 102 relative to the storage bin 200 and the transport vehicle 300. Although a portable auger assembly 100 is shown and contemplated, it may be appreciated that the auger assembly 100 is fixed relative to the storage bin 200.

Further, the auger 102 includes a conveyor 120, for example, a screw conveyor 122, arranged inside the tube 106 and extending from the lower end 108 to the upper end 110 of the tube 106. The conveyor 120 is operatively coupled to the power source 104 to enable a motion/rotation of the conveyor 120. In the embodiment, the power source 104 is adapted to rotate the screw conveyor 122 about its central axis to facilitate the transfer of the material from the lower end 108 of the tube 106 to the upper end 110 of the tube 106. In an embodiment, the power source 104 may be an internal combustion engine 124 or an electric motor. Further, the auger 102 includes a spout 130 coupled/engaged to the upper end 110 of the tube 106 and extending substantially vertically and downwardly from the upper end 110 of the tube 106. The spout 130 receives the material from the tube 106 and includes an outlet 132 through which the material exits the auger 102. Accordingly, in the embodiment, the material flows through the spout 130 under the gravity and exits the spout 130 through the outlet 132 to a location inside the transport vehicle 300. Accordingly, the outlet 132 of the spout 130 defines an outlet of the auger 102.

To control an operation of the various components of the auger assembly 100, the auger assembly 100 includes a system 140 having a first sensor 142 to detect a flow of the material at the outlet 132 of the spout 130 and a second sensor 144 to determine a filling of the material inside the transport vehicle 300 to a desired level. As shown, the first sensor 142 is mounted to the spout 130, and may be arranged proximate to the outlet 132 the spout 130. In an embodiment, the first sensor 142 may be mounted outside the spout 130. Alternatively, the first sensor 142 may be mounted inside the spout 130 and proximate to the outlet 132 of the spout 130. In an embodiment, the first sensor 142 is a limit switch 146 that may be arranged facing the outlet 132 such that the material coming out of the outlet 132 contacts the limit switch 146. Although the first sensor 142 is contemplated as the limit switch, it may be appreciated that any other type of sensor suitable to determine/detect a flow of the material from the outlet 132 may also be utilized.

Similarly, in an embodiment, the second sensor 144 is a limit switch 148 arranged downwardly and at a distance from the outlet 132 of the spout 130. The limit switch 148 may be mounted to the spout 130, and determines the filling of the material inside the transport vehicle 300 to the desired level when the limit switch 148 contacts an upper surface of an agglomerate 302 of the material disposed inside the bed of the transport vehicle 300. It may be appreciated that the distance of the limit switch 148 from the outlet 132 can be adjusted depending on a desired height of the agglomerate 302 inside the transport vehicle 300. Although the second sensor 144 is contemplated as the limit switch, it may be appreciated that any other type of sensor suitable to determine a lever of the material inside the transport vehicle 300 may also be utilized.

Further, the auger assembly 100 (i.e., the system 140) includes a controller 150 operatively coupled with one or more components of the auger assembly 100, for example, the first sensor 142, the second sensor 144, the power source 104, and the conveyor 120, to control the operation of the auger assembly 100. In an embodiment, the controller 150 control the power source 104 based on the inputs from the first sensor 142 and/or the second sensor 144. In an embodiment, the controller 150 is configured to shut-off or shutdown the power source 104 or stop the conveyor 120 in response to the determination of the filling of the transport vehicle 300 to the desired level based on the inputs from the second sensor 144. The controller 150 may determine the filling of the transport vehicle 300 to desired level when the second sensor 144 contacts the agglomerate of the material present inside the transport vehicle 300. Also, the controller 150 is configured to stop the conveyor 120 and/or shut-off/shutdown the power source 104 when the material ceases to exit from the spout 130 based on the inputs from the first sensor 142. In an embodiment, the controller 150 determines the stoppage of flow of the material from the outlet 132 when no contact of the material with the limit switch 146 is detected. In an embodiment, the controller 150 determines the stoppage of the flow of the material from the outlet 132 for a predetermined duration, i.e., when there is no contact of the material with the limit switch 146 for the predetermined duration.

In some embodiments, the auger assembly 100 includes an indicator 152, for example, a light source 154, adapted to emit a light and indicate the filing of the transport vehicle 300 to the desired level. The indicator 152 may be mounted to the auger 102 at location such that the light emitted by the light source 154 is visible to an operator of the transport vehicle 300 sitting inside the transport vehicle 300. In an embodiment, the controller 150 is configured to actuate/activate the light source 154 upon determination of the filling of the material inside the transport vehicle 300 to the desired level based on inputs from the second sensor 144. In an embodiment, the controller 150 is configured to actuate the light source 154 instead of stopping the conveyor 120 and/or the power source 104 when the controller 150 determines that the transport vehicle 300 is filled with the material to the desired level. In some embodiments, the controller 150 is configured to actuate the light source 154 along with the stopping the conveyor 120 and/or the power source 104 when the controller 150 determines the filling of the transport vehicle 300 to the desired level. In an embodiment, the light source 154 may be an LED light or an incandescent light.

Further, in some embodiments, the auger assembly 100 is configured to be operated in an auto mode and a manual mode based on user inputs. In an embodiment, the auger assembly 100 (i.e., the system 140) may include a first switch 160 adapted to be moved between a first position and a second position by a user. The auto mode is selected by positioning the first switch 160 to the first position, while the manual mode is selected by the user by positioning the first switch 160 to the second position. The controller 150 is in communication with the first switch 160, and activates the auto mode when the first switch 160 is arranged at the first position. Similarly, the controller 150 activates or operates the auger assembly 100 in the manual mode when the first switch in response to arranging the first switch 160 at the second position. In the auto mode, the controller 150 is configured to control the power source 104, the conveyor 120, the light source 154, or a combination thereof, based on the inputs from the first sensor 142 and/or the second sensor 144 as described earlier.

Moreover, in some embodiments, the controller 150 may control the auger assembly 100 or the components of the auger assembly 100 in a first auto mode and a second auto mode. To enable the selection of the auto mode as the first auto mode or the second auto mode, the auger assembly 100 (i.e., the system 140) may include a second switch 162 adapted to be displaced between a first position and a second position. The first auto mode may be selected by arranging/moving the second switch 162 to the first position, while the second mode may be selected by arranging/moving the second switch 162 to the second position. Accordingly, the controller 150 activates the auto mode as the first auto mode in response to the detection of the first switch 160 at the first position and the second switch 162 at the first position. In the first auto mode, the controller 150 is configured to shutdown/switch-off the power source 104 and/or the conveyor 120 when the filling of the transport vehicle 30 to the desired level is detected based on the inputs from the second sensor 144. Additionally, or alternatively, the controller 150 may activate the light source 154 when the filling of the transport vehicle 300 to the desired level is detected. Also, in the first auto mode, the controller 150 is configured to shutdown/switch-off the power source 104 and/or the conveyor 120 when the controller 150 determines the stoppage of the material exiting the outlet 132 of the spout 130 based on the inputs from the first sensor 142.

The controller 150 may activate the auto mode as the second mode when the first switch 160 is arranged at the first position and the second switch 162 is arranged at the second position. In the second auto mode, the controller 150 is configured to shutdown/switch-off the power source 104 and/or the conveyor 120 when the filling of the transport vehicle 300 to the desired level is detected based on the inputs from the second sensor 144. Additionally, or alternatively, the controller 150 may activate the light source 154 in response to the filling of the transport vehicle 300 to the desired level. Moreover, in the second auto mode, the controller 150 is configured to keep the power source 104 and/or the conveyor 120 running even if the controller 150 determines that the material has stopped exiting the outlet 132 of the spout 130. Although two auto modes of operation of the auger assembly 100 are contemplated, it may be appreciated that the auger assembly 100 may have only one auto mode of operation, for example, the first mode of operation. In such a case, the second switch 162 may be omitted. Also, in some embodiments, the auger assembly 100 is configured to be operated in the auto mode only, and in such cases, the first switch 160 may be omitted. In the manual mode, the controller controls the operation of the auger assembly 100 without taking inputs from the sensors 142, 144. Accordingly, the power source 104 and/or the conveyor 120 is manually switched off or shut down by the user. Further, in the manual mode, the controller 150 actuates the light source 154 when the transport vehicle 300 is filled with the material to the desired level based on the inputs from the second sensor 144.

A method for operating the auger assembly 100 for transferring the material from the storage bin 200 to the transport vehicle 300 is now described. For receiving the material from the storage bin 200 through the auger assembly 100, the operator of the transport vehicle 300 positions the transport vehicle 300 underneath the spout 130 such that the outlet 132 of the spout 130 is positioned directly above a storage bed of the transport vehicle 300. Thereafter, a user may start the power source 104 to operate the conveyor 120. Before starting the power source 104, the user may position the first switch 160 and the second switch 162 at the desired positions. For example, the user may position both the first switch 160 and the second switch 162 at the respective first positions to operate the auger assembly 100 in the first auto mode. Accordingly, the controller 150 activates the first auto mode, and starts monitoring the inputs from the first sensor 142 and the second sensor 144. In an embodiment, the controller 150 may shutdown the power source 104 and/or the conveyor 120 in response to the determination of the filling of the transport vehicle 300 to the desired level. The controller 150 may detect the filling of the transport vehicle to the desired level as the first sensor 142 contacts the material disposed inside the transport vehicle 300. In the first auto mode, the controller 150 also shut down/shut-off the power source 104 and/or the conveyor 120 in response to the determination of the stoppage of the flow of the material from the outlet 132 of the spout 130.

In some other scenarios, the user may position the first switch 160 to the first position and the second switch 162 to the second position to operate the auger assembly 100 in the second auto mode. Accordingly, the controller 150 activates the second auto mode, and starts monitoring the inputs from the second sensor 144 only. In an embodiment, the controller 150 may shutdown the power source 104 and/or the conveyor 120 in response to the determination of the filling of the transport vehicle 300 to the desired level. Accordingly, In the second auto mode, the controller 150 keeps running the power source 104 and/or the conveyor 120 irrespective of the stoppage of flow of the material from the outlet 132 of the spout 130. In this manner, the auger assembly 100 prevents the unnecessary operation of the power source 104 and/or the conveyor 120 without the need of monitoring from the user/operator, thereby reducing the cost of transferring material. Also, the auger assembly 100 prevents a spillage of the material from the transport vehicle 300 during transferring of the material from the storage bin 200.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the present disclosure and various embodiments with various modifications as are suited to the particular use contemplated.

What is claimed is:

1. An auger assembly for conveying a material, the auger assembly comprising:
an auger including a conveyor for transporting the material from a storage bin to a transport vehicle;
a power source operatively coupled to the conveyor to operate the conveyor;
a first sensor engaged to the auger and configured to detect a flow of the material from an outlet of the auger;
a second sensor configured to detect a filling of the material inside the transport vehicle to a desired level; and
a controller in communication with the first sensor, the second sensor, the power source and the auger, and configured to control the power source based on inputs from at least one of the first sensor or the second sensor.

2. The auger assembly of claim 1, wherein the controller is configured to
determine a stoppage of the flow of the material from the outlet of the auger based on the inputs from the first sensor, and
shut-down the power source in response to the determination of the stoppage of the flow of the material from the outlet of the auger.

3. The auger assembly of claim 2, wherein the controller is configured to determine the stoppage of the flow of the material from the outlet of the auger when the material ceases to exit from the outlet of the auger for a predetermined duration.

4. The auger assembly of claim 1 wherein the first sensor is a limit switch and is positioned at the outlet of the auger.

5. The auger assembly of claim 1, wherein the controller is configured to shut-down the power source in response to the determination of the filling of the transport vehicle to the desired level based on the inputs from the second sensor.

6. The auger assembly of claim 1 further including a light source and the controller is configured to actuate the light source in response to the determination of the filling of the transport vehicle to the desired level based on the inputs from the second sensor.

7. The auger assembly of claim 1, wherein the second sensor is a limit switch and the controller shut down the power source in response to a contact of the limit switch with an agglomerate of material arranged inside the transport vehicle.

8. The auger assembly of claim 1 further including a first switch adapted to activate an auto mode, wherein the controller is in communication with the first switch and is configured to control the power source based on the inputs from the at least one of the first sensor or the second sensor in response to the activation of the auto mode.

9. The auger assembly of claim 8 further including a second switch adapted to move between a first position to activate the auto mode as a first auto mode and a second position to activate the auto mode as a second auto mode.

10. The auger assembly of claim 9, wherein in the first auto mode, the controller is configured to shut down the power source in response to one of
the determination of a stoppage of the flow of the material from the outlet of the auger based on the inputs from the first sensor, or
the determination of the filing of the material inside the transport vehicle to the desired level based on the inputs from the second sensor.

11. The auger assembly of claim 9, wherein in the second auto mode, the controller is configured to shut down the power source in response to the determination of the filing of the material inside the transport vehicle to the desired level based on the inputs from the second sensor.

12. The auger assembly of claim 9, wherein in the second auto mode, the controller is configured to keep the power source running in response the determination of a stoppage of the flow of the material from the outlet of the auger based on the inputs from the first sensor.

13. The auger assembly of claim 1, wherein the power source is an engine.

14. The auger assembly of claim 1, wherein the conveyor is a screw conveyor.

15. A method for operating an auger assembly, the method comprising:
detecting, by a first sensor, a flow of a material from an outlet of an auger;
detecting, by a second sensor, a filing of the material inside the transport vehicle to a desire level; and
controlling, by a controller, a power source operating a conveyor of the auger based on inputs from the first sensor and the second sensor.

16. The method of claim 15 further including activating an auto mode by actuating a first switch, wherein the controller controls the power source based on inputs from at least one of the first sensor or the second sensor in response to the activation of the auto mode.

17. The method of claim 16 further including activating the auto mode as a first auto mode when a second switch is arranged at a first position, wherein in the first auto mode, the controller shutdown the power source in response to
the determination of the filling of the transport vehicle to the desired level based on the inputs from the second sensor, or
the determination of the stoppage of the flow from the outlet of the auger based on
the inputs from the first sensor.

18. The method of claim 16 further including activating the auto mode as a second auto mode when a second switch is arranged at a second position, wherein in the second auto mode, the controller shutdown the power source in response to the determination of the filling of the transport vehicle to the desired level based on the inputs from the second sensor.

19. The method of claim 15 further including activating a light source in response to the determination of the filling of the transport vehicle to the desired level based on the inputs from the second sensor.

20. The method of claim 15, wherein each of the first sensor and the second sensor is a limit switch.
